(19) United States
(12) Patent Application Publication
(10) Pub. No.: US 2024/0384736 A1
(43) Pub. Date: Nov. 21, 2024

(54) Embedded Car Cover

(71) Applicant: ZHEJIANG SURPASS AUTO PARTS CO.,LTD., Wenzhou City (CN)

(72) Inventors: Shiqi Zheng, Wenzhou City (CN); Yien Wang, Wenzhou City (CN); Dongdong Wang, Wenzhou City (CN); Yi Lin, Wenzhou City (CN); Lei Lin, Wenzhou City (CN)

(21) Appl. No.: 18/343,166

(22) Filed: Jun. 28, 2023

(30) Foreign Application Priority Data
May 16, 2023 (CN) 202321214935.0

(51) Int. Cl. F16B 2/06; B60P 7/02

(52) U.S. Cl. CPC F16B 2/065; B60P 7/02

(57) ABSTRACT

The invention discloses a special car cover clamp and a method of using it, including a left clamp, a right clamp, a screw and a plate, the left clamp includes a left clamping section, a mounting section and a left supporting section, the mounting section is provided with a waist hole, the right clamp includes a right clamping section, a connection section and a right supporting section, the connection section is provided with a connection hole, the plate is connected to the connection section, the plate is provided with a plate threaded hole, the screw passes through the waist hole and the connection hole and is connected to the plate threaded hole. The present invention uses screws to connect the left clamp to the right clamp, thus clamping the rail to the cargo hopper, which, together with the anti-rotation effect of the plate, makes the clamp not only a stable connection of the rail to the cargo hopper, but also the screws will not loosen and have a long service life.

### TECHNICAL FIELD

This invention is relevant to automotive spare parts, especially a special car cover clamp and a method of using it.

### BACKGROUND TECHNOLOGY

The pick-up truck (also known as a sedan truck) is used for carrying goods. Since the pick-up truck's cargo hopper is open, a cover was invented to prevent the goods inside the cargo hopper from getting wet in the rain and snow, by installing the cover on the pick-up truck's cargo hopper and using the cover to cover the goods inside the hopper to prevent the goods inside the hopper from getting wet in the rain.

The existing covers are connected to the cargo hopper by clamps, however, due to the simple structure of the existing clamps, the clamping force is often insufficient, and the problem of loosening will occur with prolonged use, secondly, the cargo needs to be supported by a support bar when it is opened, yet most of the existing support bars are connected to the body of the vehicle, which not only affects the aesthetics of the vehicle, but also makes it prone to water leakage.

### ABOUT THE INVENTION

The purpose of the present invention is to provide a special car cover clamp, by changing the original structure of the clamp, so that the clamp has a stronger grip on the car cover, and the bolt is less likely to loosen and has good stability.

In order to solve the above problems of the existing technology, the technical solution adopted in the invention is as follows.

A special car cover clamp includes a left clamp, a right clamp, a screw and a plate.

The left clamp includes a left clamping section, a mounting section and a left supporting section, the mounting section is provided with a waist hole.

The right clamp includes a right clamping section, a connection section and a right supporting section, the connection section is provided with a connection hole.

The plate is connected to the connection section and the plate is provided with a plate threaded hole.

The screw passes through the waist hole and connection hole and is connected to the plate threaded hole.

By using screws to connect the left and right clamps, thus clamping the guide rails to the cargo hopper, together with the anti-rotation function of the plate, it makes the clamp not only connect the guide rail and the cargo hopper in a stable manner, but also the screws do not loosen and have a long service life.

Further, the waist hole is an oblong shape, so that the installation height of the screw can be adjusted according to the position of the connection hole of the right clamp, it further includes a T-screw and a plum nut, the left supporting section is provided with a mounting hole, the right supporting section is provided with a half waist hole, the T-screw passes through the mounting hole and the half waist hole, the T-screw is connected with a plum nut, the upper end of the left clamp is clamped with the right clamp, the upper end of the left clamp is clamped to the right clamp, the middle of the left clamp is connected to the right clamp by screws, and the bottom of the left and right clamps are then connected with a T-screw and a plum nut, so that the upper, middle and lower sections of the left and right clamps are all connected to each other for better stability after connection.

Further, the left clamp is of a one-piece structure, a mounting section is provided between the left clamping section and the left supporting section, the left clamping section is provided with a left clamping surface, the right clamp is of a one-piece structure, a connection section is provided between the right clamping section and the right supporting section, the right clamping section is provided with a right clamping surface, the left clamping surface and the right clamping surface are both provided with an anti-slip structure, the anti-slip structure is either in the form of waves, serrations or bumps as described, the left clamping surface and the right clamping surface are provided for clamping the guide rail and the cargo hopper, the anti-slip structure is provided on both clamping surfaces to prevent sliding after the clamping of the guide rail and the cargo hopper, the left clamping section further includes a left extension, the left clamping surface is connected to the mounting section through the left extension, the height of the left extension is less than the height of the left clamping surface, the right clamping section further includes a right extension, the right clamping surface is connected to the connecting section by the right extension, the height of the right extension is less than the height of the left clamping surface, Most of the existing guide rails are rectangular frames with an opening on one side, a structure which not only has good mechanical properties but is also cheap to produce, as the height at the notch is less than the height of the internal clamping cavity, the height of the left extension is also less than the height of the left clamping surface in order to fit the structure of the guide rail.

Further, one side of the connection section is provided with a right clamping section and a right supporting section, the other side of the connection section is provided with a clamping groove and a clamping plate, the clamping plate includes a plate body, both ends of the plate body are provided with groove hooks, the groove hooks are adapted to the clamping groove, a plate groove is provided between the groove hooks and the plate body, the plate groove is adapted to the clamping plate, the plate threaded holes are provided on the plate body, the left clamping section and the left supporting section are provided on the same side of the mounting section, the side of the mounting section provided with the left clamping section and a left supporting section is called the inner side, the side of the connection section provided with a right clamping section and a right supporting section is called the inner side, the side of the connection section provided with a clamping groove is called the outer side, during installation, the inner side of the right clamping section is opposite the inner side of the left clamping section, the clamping plate is connected on the outer side of the right clamping section, through the clamping groove, the clamping plate together limit the plate and prevent the clamping plate from turning, the clamping groove is designed as a through groove and runs through both ends of the connection section. By designing the clamping groove as a through groove, the clamping plate can be inserted by one end of the clamping groove during installation, which is not only easy to install but also provides a good anti-loosening effect.

Further, the right supporting section is at an angle of 85°-95° to the connection section, the left supporting section is at an angle of 85°-95° to the mounting section, the screw pull the left and right clamps in the left and right direction, providing the two with a certain clamping force to clamp the guide rail and the cargo hopper, the T-screw and the plum nut pull the left and right clamps in an upward and downward direction, so the left supporting section is preferably or nearly perpendicular to the mounting section, similarly the right supporting section should also be nearly perpendicular to the connection section so as to ensure tension in both horizontal and vertical directions, the T-screw includes a limiting section and a threaded section, the plum nut is connected to the threaded section, with the T-screw, the limit section is used against the left supporting section to generate tension to tighten the two clamps.

Further, it includes a support bar fixing block, the support bar fixing block is of a one-piece structure, the support bar fixing block includes a connection seat, a connection block and a supporting block, the supporting block is provided with a supporting notch, by adding a support bar fixing block, the support bar can be supported, when the car cover is opened, it is usually necessary to set the support bar in order to enable the car cover to be opened for a long time, by using the support bar to support the opened car cover (similar to the support on the front hood of a vehicle), however, the existing support bar fixing block needs to be installed by drilling holes in the car body, which not only affects the aesthetic appearance of the car body, but also requires re-drill if the holes are not in the right position, the extra holes are prone to leakage, by connecting the support bar fixing block directly to the clamp, the clamping position of the clamps can be adjusted directly according to the mounting position of the support bar, eliminating the need to drill holes in the cargo hopper, not only does it affect the aesthetics of the car, moreover, the position can be adjusted as required after making it convenient to use.

Further, the supporting block is inclined, the inclination angle of the supporting block is 25°-45°, by inclined setting, it means that when the connection seat is connected to the clamp, the connection seat is in a horizontal state and the angle between the supporting block and the horizontal surface is 25°-45°, as the support bar is generally supported at an angle, setting the supporting block at an angle allows the supporting block to face the support bar, maximizing the contact area between the supporting block and the support bar and extending the service life of the support bar fixing block, the supporting notch is a “U” shaped notch, it may also be in circular or other shape. The supporting notch is designed to fit the support bar, so the specific structure can be adapted to the end structure of the support bar.

The beneficial effects of the invention are as follows.
1, The invention uses screws to connect the left clamp and the right clamp, thus clamping the guide rails to the cargo hopper, and together with the anti-rotation function of the plate, it makes the clamps not only connect the guide rails to the cargo hopper in a stable manner, but also the screws do not loosen and have a long service life.
2, The invention applies a T-shaped screw, using its limiting section against the left supporting section to generate tension to pull the two clamps tight, forming a vertical pull, making the clamps consistently clamping the guide rails.
3. The invention connects the support bar fixing block directly to the clamps, which enables the position of the clamps to be adjusted in accordance with the length and support position of the support bar, and thus the position of the support bar fixing block, which can be adapted to different support bars.

### DESCRIPTION OF DRAWINGS

FIG. 1 is the structure schematic diagram of the invention.

FIG. 2 is the structure schematic diagram 1 of the right clamp of the invention.

FIG. 3 is the structure schematic diagram 2 of the right clamp of the invention.

FIG. 4 is the structure schematic diagram 1 of the left clamp of the invention.

FIG. 5 is the structure schematic diagram 2 of the left clamp of the invention.

FIG. 6 is the structure schematic diagram of the plate of the invention.

FIG. 7 is the structure schematic diagram of the T-shaped screw of the invention.

FIG. 8 is the partial structure schematic diagram of the guide rail of the invention.

FIG. 9 is the structure schematic diagram of the support bar fixing block of the invention.

FIG. 10 is the structure schematic diagram of Embodiment 11 in the invention.

FIG. 11 is the partial enlarged view of part A in the FIG. 10.

FIG. 12 is the structure schematic diagram of Embodiment 12 in the invention.

FIG. 13 is the partial enlarged view of part B in Embodiment 12.

In the figures: 11—Left clamp; 111—Left clamping section; 1111—Left clamping surface; 1112—Left extension section; 112—Mounting section; 1121—Waist hole; 113—Left supporting section; 1131—Mounting hole; 12—Right clamp; 121—Right clamping section; 1211—Right clamping surface; 1212—Right extension section; 122—Connection section; 1221—Connection hole; 1222—Clamping groove; 1223—Clamping plate; 123—Right supporting section; 1231—Half-waist hole; 13—Screw; 14—T-screw; 141—Limiting section; 142—Threaded section; 15—Plum nut; 16—Plate; 161—Plate body; 162—Plate threaded hole; 163—Groove hook; 164—Plate groove; 171—Connection seat; 172—Connection block; 173—Supporting block; 174—Supporting notch; 18—Auxiliary member; 181—Auxiliary fixing hole; 2—Guide rail; 21—Clamping cavity; 22—Notch; 23—Fixing hole.

### The Concrete Method to Carry Out

The following instruction further explains the invention's concrete implementation method.

In order to enable a clearer understanding of the objects mentioned above, features and advantages of the present invention, the invention is described in detail below in connection with the accompanying drawings and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense, for example, it may be a fixing connection, it can also be a detachable connection or an integral connection, it can be a mechanical connection or an electrical connection, it can be a direct connection or an indirect connection through an intermediate media. And it can be internal connection within two assemblies. For those of ordinary skill in this field, specific meanings of the above terms in the present invention can be understood in specific situations.

The specific embodiments of the present invention will be described in detail below in connection with the accompanying drawings. It should be understood that the specific embodiments described herein are intended only to illustrate and explain the present invention and not to limit it.

### Embodiment 1

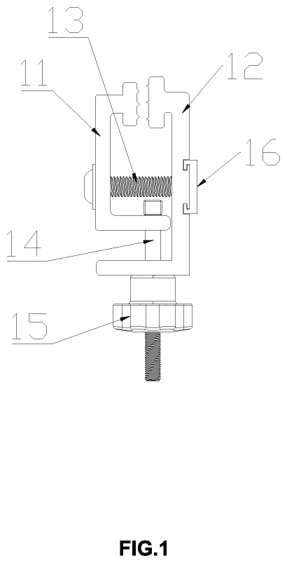

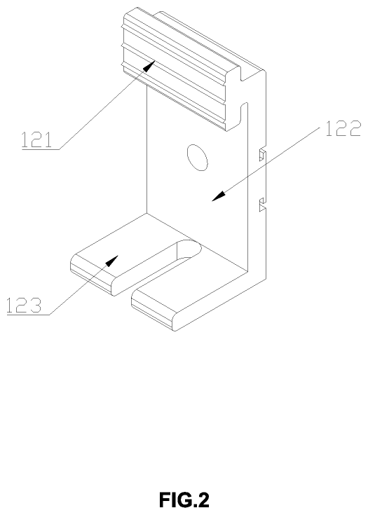

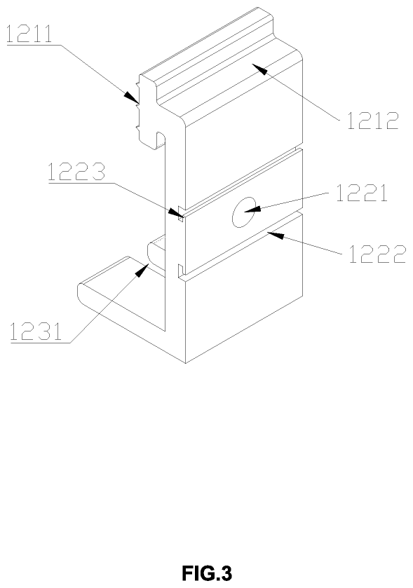

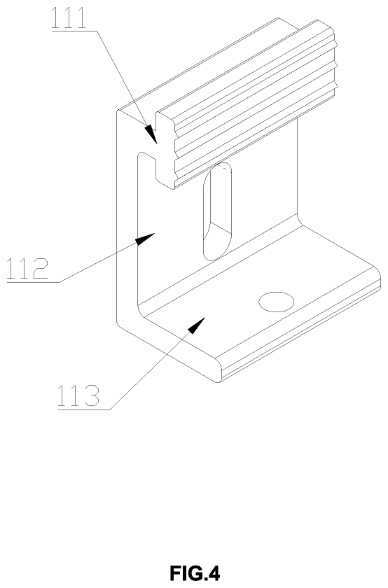

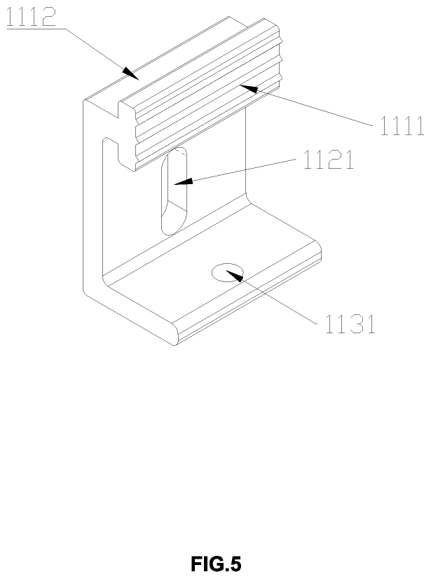

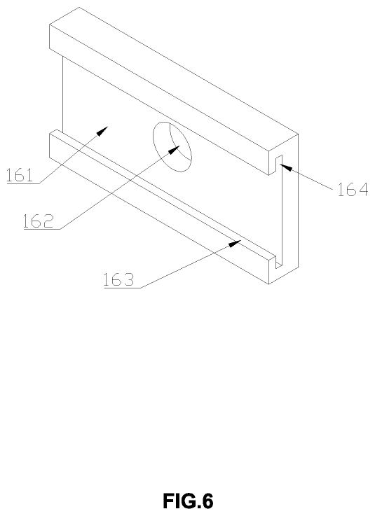

As shown in FIGS. 1 to 6, a special car cover clamp includes a left clamp 11, a right clamp 12, a screw 13, a plate 16 and a tension assembly;

The left clamp 11 includes a left clamping section 111, a mounting section 112 and a left supporting section 113, the mounting section 112 is provided with a waist hole 1121;

The right clamp 12 includes a right clamping section 121, a connection section 122 and a right supporting section 123, the connection section 122 is provided with a connection hole 1221,

The plate 16 is provided with a plate threaded hole 162,

The screw 13 passes through the waist hole 1121 and the connection hole 1221 and is connected to the plate threaded hole 162,

The tension assembly is provided for connecting the left clamp 11 to the right clamp 12.

### Embodiment 2

As shown in FIGS. 1 to 5, a special car cover clamp includes a left clamp 11, a right clamp 12, a screw 13 and a tension assembly;

The left clamp 11 includes a left clamping section 111, a mounting section 112 and a left supporting section 113, the mounting section 112 is provided with a waist hole 1121

The right clamp 12 includes a right clamping section 121, a connection section 122 and a right supporting section 123, the connection section 122 is provided with a connection hole 1221.

The screw 13 passed through the waist hole 1121 and threads into the connection hole 1221.

The clamp (here the clamp can be either the left clamp 11 or the right clamp 12) is connected with a support bar fixing block for connecting the support bar.

By using the screws 13 to connect the left clamp 11 to the right clamp 12, thus clamping the guide rail 2 to the cargo hopper, together with the anti-rotation function of the plate 16, it makes the clamp not only connect the guide rail 2 to the cargo hopper in a stable manner, but also the screws 13 do not loosen and have a long service life.

The connection hole 1221 can be a threaded hole or light hole, if the connection hole 1221 is a threaded hole, the screw 13 passes through the connection hole 1221 and is threaded to the connection hole 1221 and the plate threaded hole 162, or if the connection hole 1221 is a light hole, the screw 13 simply passes through the connection hole 1221.

### Embodiment 3

On the basis of Embodiment 1 or 2, the waist hole 1121 is an oblong shape (as long as it is ensured that the waist hole 1221 is an elongated hole to facilitate adjustment of the mounting height of the left clamp 11) and the mounting height of the screw 13 can be adjusted according to the position of the connection hole 1221 of the right clamp 12.

The tension assembly includes a T-screw 14 and a nut, the left supporting section 113 is provided with a mounting hole 1131, the right supporting section 123 is provided with a half-waist hole 1231, the T-screw 14 passes through the mounting hole 1131 and half-waist hole 1231, the T-screw 14 is connected to a nut, the nut can be a plum nut 15, or a butterfly nut, or any other nut.

The tension assembly further includes a bolt.

The tension assembly is either of the construction of the T-screw 14 and the plum nut 15, or alternatively the bolts may be used to tension the left clamp 11 and the right clamp 12 together.

The upper end of the left clamp 11 is clamped to the right clamp 12, the middle of the left clamp 11 is connected to the right clamp 12 by a screw 13, and then the bottom of the left clamp 11 and the right clamp 12 are connected using the T-screw 14 and the plum nut 15, so that the upper, middle and lower sections of the left clamp 11 and the right clamp 12 are all connected to each other for better stability after connection.

During installation, the left supporting section 113 is higher than the right supporting section 123, the T-screw 14 passes through the mounting hole 1131 and the half-waist hole 1231, and then the plum nut 15 is tightened to pull the left clamp 11 and the right clamp 12 tightly in a vertical direction.

### Embodiment 4

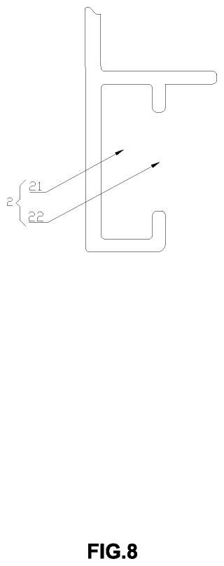

On the basis of Embodiment 3, as shown in FIG. 8, the left clamp 11 is of a one-piece structure, a mounting section 112 is provided between the left clamping section 111 and the left supporting section 113, the left clamping section 111 is provided with a left clamping surface 1111.

The right clamp 12 is of a one-piece structure, the connection section 122 is provided between the right clamping section 121 and the right supporting section 123, the right clamping section 121 is provided with a right clamping surface 1211.

The left clamping surface 1111 and the right clamping surface 1211 are both provided with an anti-slip structure, the anti-slip structure is either in the form of waves, serrations or bumps as described, the left clamping surface 1111 and the right clamping surface 1211 are provided for clamping the guide rail 2 and the cargo hopper, the anti-slip structure is provided on both clamping surfaces to prevent sliding after clamping the guide rail 2 to the cargo hopper.

The left clamping section 111 further includes a left extension 1112, the left clamping surface 1111 is connected to the mounting section 112 through the left extension 1112, the height of the left extension 1112 is less than the height of the left clamping surface 1111.

The right clamping section 121 further includes a right extension 1212, the right clamping surface 1211 is connected to the connection section 122 through the right extension 1212, the height of the right extension 1212 is less than the height of the right clamping surface 1211.

Most of the existing guide rails 2 are rectangular frames with an opening on one side (including a clamping cavity 21 and a notch 22), a structure which not only has good mechanical properties but is also cheap to produce. As the height at the notch 22 is less than the height of the internal clamping cavity 21, the height of the left extension 1112 is also less than the height of the left clamping surface 1111 in order to fit the structure of the guide rail 2.

### Embodiment 5

On the basis of Embodiment 4, one side of the connection 122 is provided with a right clamping section 121 and a right supporting section 123, the other side of the connection 122 is provided with a clamping groove 1222 and a clamping plate 1223.

The plate 16 includes a plate body 161, both ends of the plate body 161 are provided with groove hooks 163, the groove hooks 163 are adapted to the clamping groove 1222, a plate groove 164 is provided between the groove hooks 163 and the plate body 161, the plate groove 164 is adapted to the clamping plate 1223, the plate threaded holes 162 are provided on the plate body 161.

The left clamping section 111 and left supporting section 113 are provided on the same side of the mounting section 112.

The side of the mounting section 112 provided with a left clamping section 111 and a left supporting section 113 is called the inner side, the side of the attachment section 122 provided with a right clamping section 121 and a right supporting section 123 is called the inner side, the side of the connection section 122 provided with a clamping groove 1222 is called the outer side, during installation, the inner side of the right clamping section 12 is opposite the inner side of the left clamping section 11, the plate 16 is connected on the outer side of the right clamping section 12, through the clamping groove 1222, the clamping plate 1223 together limit the plate 16 and prevent the plate 16 from turning.

The clamping groove 1222 is designed as a through groove and runs through both ends of the connection 122.

By designing the clamping groove 1222 as a through groove, the plate 16 can be inserted by one end of the clamping groove 1222 during installation, which is not only easy to install, but also provides a good anti-loosening effect.

### Embodiment 6

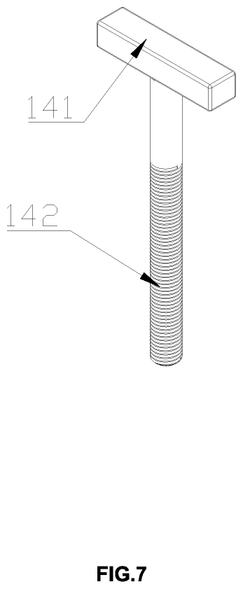

On the basis of Embodiment 5, as shown in FIG. 7, the right supporting section 123 is at an angle of 85°-95° to the connection section 122.

The screw 13 pull the left clamp 11 and the right clamp 12 in the left and right direction, providing the two with a certain clamping force to clamp the guide rail 2 and the cargo hopper, the T-screw 14 and the plum nut 15 pull the left clamp 11 and the right clamp 12 in an upward and downward direction, so that the left supporting section 113 is preferably or nearly perpendicular to the mounting part 112, similarly the right supporting part 123 should also be nearly perpendicular to the connecting part 122, so as to ensure tension in both horizontal and vertical directions.

The T-screw 14 includes a limiting section 141 and a threaded section 142, the plum nut 15 is connected to the threaded section 142.

With the T-screw 14, the limit section 141 is used against the left supporting section 113 to generate tension to tighten the two clamps.

### Embodiment 7

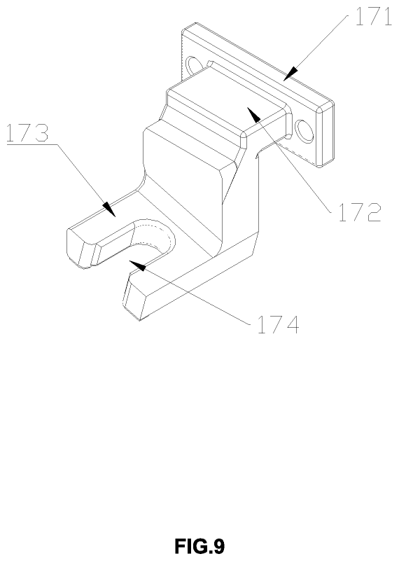

On the basis of Embodiment 6, as shown in FIG. 9, it further includes a support bar fixing block, the support bar fixing block is of a one-piece structure, the support bar fixing block includes a connection seat 171, a connection block 172 and a supporting block 173, the supporting block 173 is provided with a supporting notch 174.

By adding the support bar fixing block, the support bar can be supported, when the car cover is opened, it is usually necessary to set the support bar in order to enable the car cover to be opened for a long time, by using the support bar to support the opened car cover (similar to the support of the front hood of a vehicle), however, the existing support bar fixing block needs to be installed by drilling holes in the car body, which not only affects the aesthetic appearance of the car body, but also requires reopening the holes if the holes are not in the right position The extra holes are prone to leakage.

By connecting the support bar fixing block directly to the clamp, the clamping position of the clamp can be adjusted directly according to the mounting position of the support bar, eliminating the need to drill holes in the cargo hopper, not only does it not affect the aesthetics of the car body, moreover, the position can be adjusted as required after installation, making it convenient to use.

The supporting block 173 is inclined set.

The inclination angle of the supporting block 173 is 25°-45°.

By inclined setting, it means that when the connection seat 171 is connected to the clamp, the connection seat 171 is in a horizontal state and the angle between the supporting block 173 and the horizontal plane is 25°-45°.

As the support bar is generally supported at an angle, setting the supporting block 173 at an angle allows the supporting block 173 to face the support bar, maximizing the contact area between the supporting block 173 and the support bar and extending the service life of the support bar fixing block.

The supporting notch 174 is a “U” shaped notch.

The supporting notch 174 may also be in a circular shape or other shape.

The supporting notch 174 is designed to fit the support bar, so that the specific structure can be adapted to the end structure of the support bar.

### Embodiment 8

A special car cover clamp includes a left clamp 11, a right clamp 12, a screw 13, a plate 16 and a tension assembly.

The left clamp 11 and the right clamp 12 are arranged in opposite directions, the left clamp 11 is provided with a waist hole 1121 and the right clamp 12 is provided with a connection hole 122.

The plate 16 is provided with a plate threaded hole 162.

The screw 13 passes through the waist hole 1121 and the connection hole 1221 and is connected to the plate threaded hole 162.

The tension assembly is provided to connect the left clamp 11 to the right clamp 12.

The clamps are used to clamp the guide rail 2 to the car body (here the car body mainly refers to the carriage or cargo hopper).

To install, place the left clamping surface 1111 on the side of the cargo hopper, place the T-screw 14 from above downwards to make the threaded section 142 passes through the mounting hole 1131, then connect the plate 16 to the right clamp 12, followed by the insertion the guide rail 2 from the end of the cargo hopper so that the guide rail 2 is tight to the cargo hopper, moreover, the right clamping surface 1211 is located inside the clamping cavity 21, make the left clamp 11 and the right clamp 12 clamp clamped by screwing the screw 13, use the left clamping surface 1111 and the right clamping surface 1211 to clamp the cargo hopper and the guide rail 2, and finally tighten the plum nut 15 at the threaded section 142.

### Embodiment 9

A special car cover clamp including a left clamp 11, a right clamp 12, a screw 13, a plate 16 and a tension assembly.

The left clamp 11 and the right clamp 12 are provided in opposite directions, the left clamp 11 is provided with a waist hole 1121 and the right clamp 12 is provided with a connection hole 1221.

The plate 16 is provided with a plate threaded hole 162.

The screw 13 passes through the waist hole 1121 and the connection hole 1221 and is connected to the plate threaded hole 162.

The tension assembly is provided to connect the left clamp 11 to the right clamp 12.

The clamps are used to connect guide rail A and guide rail B at the same time as securing guide rail 2 to the car body (both guide rail A and guide rail B are guide rail 2, other than that sometimes guide rail 2 is designed in a segmented structure for ease of transport, with guide rail A and guide rail B each referring to a segment of guide rail 2).

To install, place the left clamping surface 1111 on the side of the cargo hopper, place the T-screw 14 from above downwards to make the threaded section 142 passes through the mounting hole 1131, then the plate 16 is connected to the right clamp 12, followed by the insertion of the guide rail A and guide rail B from the end of the cargo hopper, so that guide rail A and guide rail B are tight to the cargo hopper, making the clamp located at the connection of guide rail A and guide rail B, moreover, the right clamping surface 1211 is located inside the clamping cavity 21 of the guide rail A and guide rail B, make the left clamp 11 and the right clamp 12 clamped by screwing the screw 13, use the left clamping surface 1111 and the right clamping surface 1211 to clamp the cargo hopper and the guide rail A and guide rail B together at the same time, and finally tighten the plum nut 15 in the threaded section 142.

### Embodiment 10

A special car cover clamp including a left clamp 11, a right clamp 12, a screw 13 and a plate 16.

The left clamp 11 and the right clamp 12 are arranged in opposite directions, the left clamp 11 is provided with a waist hole 1121 and the right clamp 12 is provided with a connection hole 1221.

The plate 16 is provided with a plate threaded hole 162.

The screw 13 passes through the waist hole 1121 and the connection hole 1221 and is connected to the plate threaded hole 162;

The clamp is provided to connect a support bar fixing block for connecting the support bar.

To install, the support bar fixing block is first attached to the right clamp 12 (it can also be attached to the left clamp 11 in practice), place the left clamping surface 1111 on the side of the cargo hopper, place the T-screw 14 from above downwards to make the threaded section 142 passes through the mounting hole 1131, then the plate 16 is connected to the right clamp 12, followed by the insertion of the guide rail 2 from the end of the cargo hopper, so that the guide rail 2 is tight against the cargo hopper, And the right clamping surface 1211 is located inside the clamping cavity 21, according to the installation position of the support bar fixing block, adjust the position of the clamps, after the position is adjusted, tightening the screw 13 makes the left clamp 11 to clamp the right clamp 12, using the left clamping surface 1111 and the right clamping surface 1211 to clamp the cargo hopper and the guide rail 2, and finally tighten the plum nut 15 in the threaded section 142.

### Embodiment 11

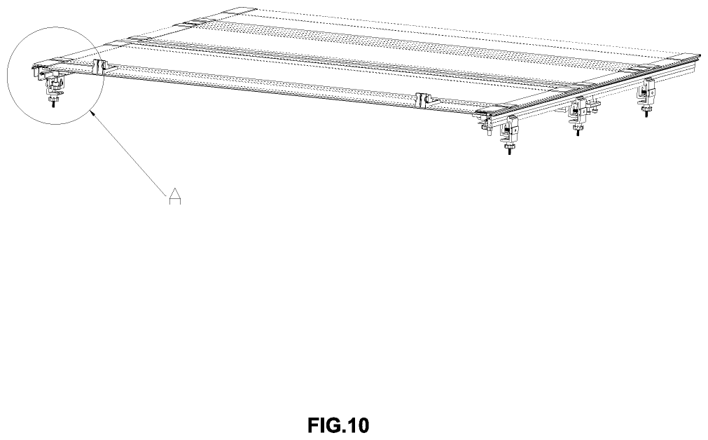

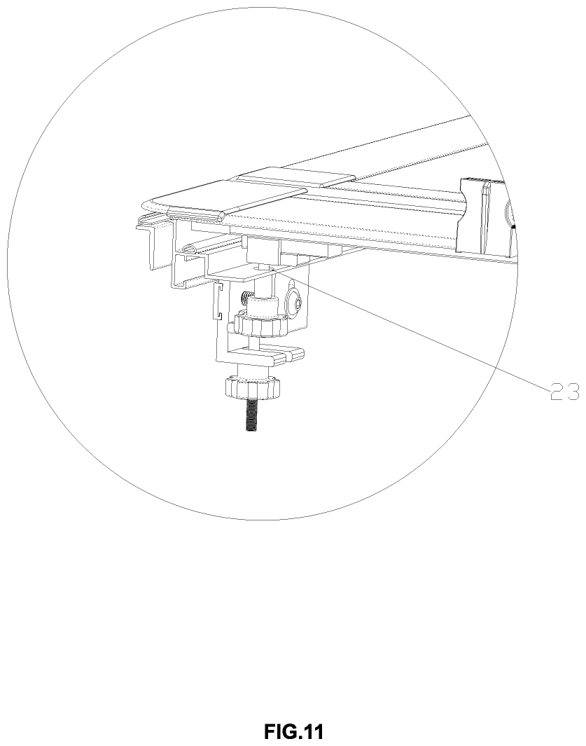

As shown in FIGS. 10 and 11, a special car cover clamp including a left clamp 11, a right clamp 12 and screws 13.

The left clamp 11 includes a left clamping section 111, a mounting section 112 and a left supporting section 113, the mounting section 112 is provided with a waist hole 1121.

The right clamp 12 includes a right clamping section 121, an connection section 122 and a right supporting section 123, the connection section 122 is provided with a connection hole 1221.

The screw 13 passes through the waist hole 1121 and is threaded into the connection hole 1221. The left clamping section 111 and the right clamping section 121 are provided for clamping the guide rail 2, the guide rail 2 is provided with a fixing hole 23, the fixing hole 23 is provided for connecting the car cover.

By providing the fixing holes 23 in the guide rail 2, the screw is passed through the fixing holes 23 when in use and the car cover is limited using the fixing holes 23 in the guide rail 2.

### Embodiment 12

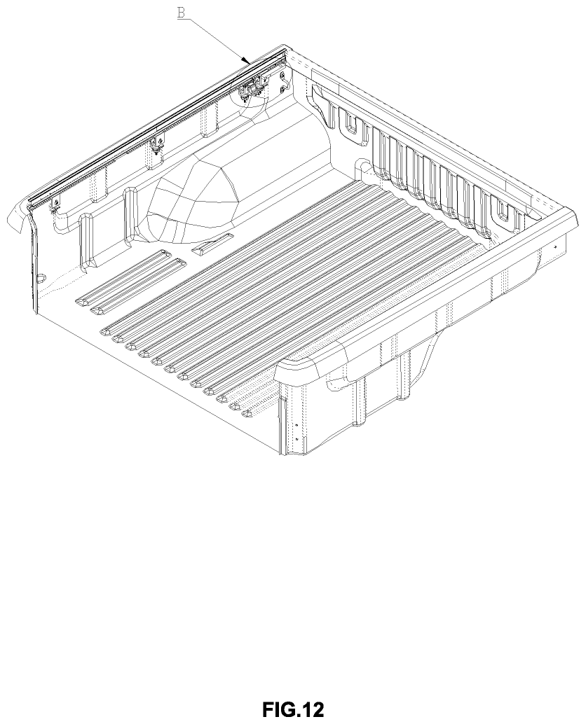

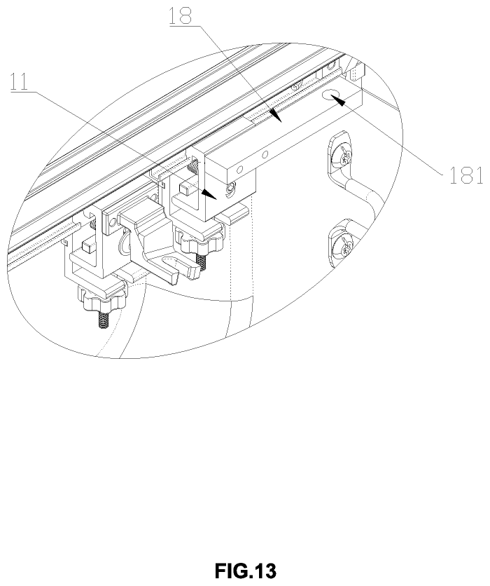

As shown in FIGS. 12 and 13, a special car cover clamp including a left clamp 11, a right clamp 12, a screw 13 and an auxiliary member 18.

The left clamp 11 includes a left clamping section 111, a mounting section 112 and a left supporting section 113, the mounting section 112 is provided with a waist hole 1121.

The right clamp 12 includes a right clamping section 121, an connection section 122 and a right supporting section 123, the connection section 122 is provided with a connection hole 1221.

The screw 13 passes through the waist hole 1121 and is threaded into the connection hole 1221.

The auxiliary member 18 is attached to the left clamp 11 or the right clamp 12, the auxiliary member 18 is provided with an auxiliary fixing hole 181, the auxiliary fixing hole 181 is used to connect the car cover.

By adding the auxiliary member 18, the auxiliary member 18 is directly connected to the clamps, when in use, a screw is used to pass through the auxiliary fixing hole 18 and the cover is fixed and limited using the auxiliary member 18 to ensure the stability of the cover.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

What is claimed is:

1. A special car cover clamp, wherein, it includes: a left clamp (11), a right clamp (12), a screw (13), a plate (16) and a tension assembly;
The left clamp (11) and the right clamp (12) are provided opposite each other, the left clamp (11) is provided with a waist hole (1121) and the right clamp (12) is provided with a connection hole (1221);
The plate (16) is provided with a plate threaded hole (162);
The screw (13) passes through the waist hole (1121) and connection hole (1221) and is connected to the plate threaded hole (162);
The tension assembly is provided for connecting the left clamp (11) to the right clamp (12);
The clamps are used to clamp the guide rails (2) to the car body.

2. A special car cover clamp, wherein, it includes: a left clamp (11), a right clamp (12), a screw (13), a plate (16) and a tension assembly;
The left clamp (11) and the right clamp (12) are provided opposite each other, the left clamp (11) is provided with a waist hole (1121) and the right clamp (12) is provided with a connection hole (1221);
The plate (16) is provided with a plate threaded hole (162);
The screw (13) passes through the waist hole (1121) and connection hole (1221) and is connected to the plate threaded hole (162);
The tension assembly is provided for connecting the left clamp (11) to the right clamp (12); The clamps are used to clamp the guide rails (2) to the car body, while connecting the guide rails A and B.

3. A special car cover clamp, wherein, it includes: a left clamp (11), a right clamp (12), a screw (13), a plate (16) and a tension assembly;
The left clamp (11) and the right clamp (12) are provided opposite each other, the left clamp (11) is provided with a waist hole (1121), the right clamp (12) is provided with a connection hole (1221);
The plate (16) is provided with a plate threaded hole (162);
The screw (13) passes through the waist hole (1121) and connection hole (1221) and is connected to the plate threaded hole (162);
The tension assembly is provided for connecting the left clamp (11) to the right clamp (12); The clamps are connected with a support bar fixing block for connecting the support bar.

4. A special car cover clamp, wherein, it includes: a left clamp (11), a right clamp (12), a screw (13), a plate (16) and a tension assembly;
The left clamp (11) includes a left clamping section (111), a mounting section (112) and a left supporting section (113), the mounting section (112) is provided with a waist hole (1121);
The right clamp (12) includes a right clamping section (121), an connection section (122) and a right supporting section (123), the connection section (122) is provided with a connection hole (1221);
The plate (16) is provided with a plate threaded hole (162);
The screw (13) passes through the waist hole (1121) and connection hole (1221) and is connected to the plate threaded hole (162);
The tension assembly is provided for connecting the left clamp (11) to the right clamp (12).

5. A special car cover clamp, wherein, it includes: a left clamp (11), a right clamp (12), a screw (13) and a tension assembly;
The left clamp (11) includes a left clamping section (111), a mounting section (112) and a left supporting section (113), the mounting section (112) is provided with a waist hole (1121);
The right clamp (12) includes a right clamping section (121), a connection section (122) and a right supporting section (123), the connection section (122) is provided with a connection hole (1221);
The screw (13) passes through the waist hole (1121) and connection hole (1221) and is connected to the plate threaded hole (162);
The tension assembly is provided for connecting the left clamp (11) to the right clamp (12).

6. A special car cover clamp, wherein, it includes: a left clamp (11), a right clamp (12) and a screw (13);
The left clamp (11) includes a left clamping section (111), a mounting section (112) and a left supporting section (113), the mounting section (112) is provided with a waist hole (1121);
The right clamp (12) includes a right clamping section (121), a connection section (122) and a right supporting section (123), the connection section (122) is provided with a connection hole (1221);
The screw (13) passes through the waist hole (1121) and connection hole (1221) and is connected to the plate threaded hole (162);
The left clamping section (111) and the right clamping section (121) are provided for clamping the guide rail (2), the guide rail (2) is provided with a fixing hole (23), the fixing hole (23) is used for connecting the car cover.

7. A special car cover clamp, wherein, it includes: a left clamp (11), a right clamp (12), a screw (13) and an auxiliary member (18);
The left clamp (11) includes a left clamping section (111), a mounting section (112) and a left supporting section (113), the mounting section (112) is provided with a waist hole (1121);
The right clamp (12) includes a right clamping section (121), a connection section (122) and a right supporting section (123), the connection section (122) is provided with a connection hole (1221);
The screw (13) passes through the waist hole (1121) and connection hole (1221) and is connected to the plate threaded hole (162);
The auxiliary member (18) is connected to the left clamp (11) or the right clamp (12), the auxiliary member (18) is provided with an auxiliary fixing hole (181), the auxiliary fixing hole (181) is used to connect the car cover.

8. A special car cover clamp according to claim 4, wherein, the tension assembly includes a T-screw (14) and a nut, the left supporting section (113) is provided with a mounting hole (1131), the right supporting section (123) is provided with a half-waist hole (1231), the T-screw (14) is passed through the mounting hole (1131) and the half-waist hole (1231), the T-screw (14) is connected with a nut.

9. A special car cover clamp according to claim 8, wherein, the nut includes a butterfly nut or a plum nut (15).

10. A special car cover clamp according to claim 4, wherein, the left clamp (11) is of a one-piece structure, the mounting section (112) is provided between the left clamping section (111) and the left supporting section (113), the left clamping section (111) is provided with a left clamping surface (1111);
The right clamp (12) is of a one-piece structure, a connection section (122) is provided between the right clamping section (121) and the right supporting section (123), the right clamping section (121) is provided with a right clamping surface (1211);
The left clamping surface (1111) and the right clamping surface (1211) are both provided with an anti-slip structure.

11. A special car cover clamp according to claim 4, wherein, the left clamp section (111) further includes a left extension (1112), the left clamping surface (1111) is connected to the mounting section (112) through the left extension (1112), the height of the left extension (1112) is less than the height of the left clamping surface (1111);
The right clamp section (121) further includes a right extension (1212), the right clamping surface (1211) is connected to the attachment section (122) through the right extension (1212), the height of the right extension (1212) is less than the height of the right clamping surface (1211).

12. A special car cover clamp according to claim 4, wherein, one side of the connection section (122) is provided with a right clamping section (121) and a right supporting section (123), the other side of the connection section (122) is provided with a clamping groove (1222) and a clamping plate (1223);
The plate (16) includes a plate body (161), both end of the plate body (161) is provided with groove hooks (163), the groove hooks (163) are adapted to the clamping groove (1222), a plate groove (164) is provided between the groove hook (163) and the plate body (161), the plate groove (164) is adapted to the clamping plate (1223), the plate threaded holes (162) are provided on the plate body (161).

13. A special car cover clamp according to claim 12, wherein, the clamping groove (1222) is designed as a through groove, the clamping groove (1222) runs through both ends of the connection section (122).

14. A special car cover clamp according to claim 4, wherein, the angle between the right supporting section (123) and the connecting section (122) is 85°-95°, the angle between the left supporting section (113) and the mounting section (112) is 85°-95°.

15. A special car cover clamp according to claim 8, wherein, the T-screw (14) includes a limiting section (141) and a threaded section (142), the plum nut (15) is connected to the threaded section (142).

16. A special car cover clamp according to claim 4, wherein, it further includes a support bar fixing block, the support bar fixing block is of a one-piece structure, the support bar fixing block includes a connection seat (171), a connection block (172) and a supporting block (173), the supporting block (173) is provided with a supporting notch (174).

17. A special car cover clamp according to claim 16, wherein, the supporting block (173) is inclined.

18. A method of using a special car cover clamp according to claim 4, wherein, the clamp is used to fix the guide rail (2) to the car body.

19. A method of using a special car cover clamp according to claim 4, wherein, the clamp is used to fix both guide rail A and guide rail B to the car body.

20. A method of using a special car cover clamp according to claim 17, wherein, the clamp is provided with a support bar fixing block for connecting the support bar.

21. The special car cover clamp according to claim 5, wherein, the tension assembly includes a T-screw (14) and a nut, the left supporting section (113) is provided with a mounting hole (1131), the right supporting section (123) is provided with a half-waist hole (1231), the T-screw (14) is passed through the mounting hole (1131) and the half-waist hole (1231), the T-screw (14) is connected with a nut.

22. The special car cover clamp according to claim 21, wherein, the nut includes a butterfly nut or a plum nut (15).

23. A special car cover clamp according to claim 5, wherein, the left clamp (11) is of a one-piece structure, the mounting section (112) is provided between the left clamping section (111) and the left supporting section (113), the left clamping section (111) is provided with a left clamping surface (1111);
the right clamp (12) is of a one-piece structure, a connection section (122) is provided between the right clamping section (121) and the right supporting section (123), the right clamping section (121) is provided with a right clamping surface (1211);
the left clamping surface (1111) and the right clamping surface (1211) are both provided with an anti-slip structure.

24. The special car cover clamp according to claim 5, wherein, the left clamp section (111) further includes a left extension (1112), the left clamping surface (1111) is connected to the mounting section (112) through the left extension (1112), the height of the left extension (1112) is less than the height of the left clamping surface (1111);
the right clamp section (121) further includes a right extension (1212), the right clamping surface (1211) is connected to the attachment section (122) through the right extension (1212), the height of the right extension (1212) is less than the height of the right clamping surface (1211).

25. The special car cover clamp according to claim 5, wherein, the angle between the right supporting section (123) and the connecting section (122) is 85°-95°, the angle between the left supporting section (113) and the mounting section (112) is 85°-95°.

26. The special car cover clamp according to claim 21, wherein, the T-screw (14) includes a limiting section (141) and a threaded section (142), the plum nut (15) is connected to the threaded section (142).

27. The method of using a special car cover clamp according to claim 5, wherein, the clamp is used to fix the guide rail (2) to the car body.

28. The method of using a special car cover clamp according to claim 5, wherein, the clamp is used to fix both guide rail A and guide rail B to the car body.
